(19) United States
(12) Patent Application Publication
(10) Pub. No.: US 2004/0111579 A1
(43) Pub. Date: Jun. 10, 2004

(54) Apparatus and method for memory device block movement

(75) Inventors: Jang-Min Lin, Taipei (TW); Chung Chuan Wang, Taipei (TW)

Correspondence Address: QUINTERO LAW OFFICE, 1617 BROADWAY, 3RD FLOOR, SANTA MONICA, CA, 90404, US

(73) Assignee: Comax Semiconductor Inc.

(21) Appl. No.: 10/338,246

(22) Filed: Jan. 8, 2003

(30) Foreign Application Priority Data
Dec. 10, 2002 (TW) 91135709

(51) Int. Cl. G06F 12/00

(52) U.S. Cl. 711/165; 711/104

(57) ABSTRACT

A method for memory device block movement. The method comprises the steps of decoding a block movement command carrying a start address, destination address and move length to generate a block movement signal, generating a first, second and third loading signal when the block movement signal is asserted, receiving the start address, destination address and move length when the loading signals are asserted respectively, during a read cycle, outputting the start address to the memory device to transfer data of a buffer length at a location beginning from the start address in the memory device into a buffer, during a write cycle, transferring the data from the buffer to a location beginning from the destination address in the memory device, subtracting the move length by the buffer length, and adding the buffer length to the start and destination address.

### BACKGROUND OF THE INVENTION

1. Field of the Invention

The present invention relates to an apparatus and method for memory device block movement and particularly to a smart 1T-SRAM, SRAM, DRAM or flash memory with block movement function.

2. Description of the Prior Art

As the advances of process technology make gates cheaper and faster, complexity of chip function increases dramatically. However, market pressures associated with high volumes and short product life cycles contribute to the need to constantly reduce design times. This increase in chip complexity combined with increasing cost of time-to-market delays requires substantial improvements in the efficiency of the IC design process. The movement from full custom to standard ASIC design and to SoC design is driven by this unrelenting demand for improvement in IC design efficiency. Moving to block-based SoC design, increased complexity requires effective management of interfaces between different blocks. Advances in the standardization of on-chip buses and the improvement of silicon performance helps to simplify system partitioning. However, the integration of functional blocks implemented with incompatible technology represents a very challenging roadblock to the rapid adoption of SoC design. Traditional memory devices are specially crafted on memory devices are specially crafted on dedicated memory processes. For example, DRAM devices are fabricated with processes containing 3 or 4 layers of process generation. The embedded DRAM process time lag usually exceeds one full process generation. The delay in the deployment of embedded processes compared to the baseline logic process results in higher memory bit cost and lower system performance. Therefore, the availability of high-performance embedded memory in standard logic process removes one of the biggest roadblocks for SoC design. The use of six-transistor SRAMs in standard logic process provides limited solution at the cost of low bit-density. A much better solution is provided by the 1T-SRAM technology.

For innovative portable and wireless devices, SoCs containing several processors, memories and specialized modules are obviously required. Performance and lower power consumption, are main issues in the design of such SoCs. In deep submicron technologies, SoCs contain several millions of transistors and have to work at lower and lower supply voltages to avoid high power consumption. Consequently, digital libraries as well as ROM and SRAM memories have to be designed to work at very low supply voltages and be very robust while considering wire delays, signal input slopes, noise, and crosstalk effects. Low-power SoCs will be based on low-power components, such as processor cores, memories and libraries that are available with favorable performance, i.e. 20′000 to 100′000 MIPS/watt for some cores (using low-power techniques such as gated clocks). However, memories are the main consumers on a SoC and several techniques at the architecture and electrical levels have to be applied to reduce their power consumption (generally based on caches, DWL, bitline splitting, low swing).

Therefore, 1T-SRAMs and LPSRAMs are popularly used in portable devices with limited power and high bit-density memories, such as PDAs or mobile phones. However, these memory devices are not equipped with circuits dedicated for block movement, as performed by a DSP or CPU. This interrupts the operation and degrades the performance of the DSP and CPU.

### SUMMARY OF THE INVENTION

The object of the present invention is to provide a smart 1T-SRAM, SRAM, SDRAM or flash memory with block movement function, wherein the CPU or DSP only needs to transmit a block movement command to a peripheral circuit of the memory and block movement is performed by the circuit. This avoids interruption and performance degradation of the DSP or CPU.

The present invention provides an apparatus for memory device block movement comprising means for decoding a block movement command carrying a start address, destination address and move length to generate a block movement signal, means for generating a first, second and third loading signal when the block movement signal is asserted, means for receiving the start address, destination address and move length when the first, second and third loading signal are asserted respectively, means for outputting the start address to the memory device to retrieve data of a buffer length at a location beginning from the start address in the memory device and transferring the data into a buffer during a read cycle, means for outputting the destination address to the to the memory device and transferring the data from the buffer into the memory device at a location beginning from the destination address during a write cycle, and means for subtracting the move length by the buffer length, and adding the buffer length to the start address and destination address.

The present invention further provides a method for memory device block movement comprising the steps of decoding a block movement command carrying a start address, destination address and move length to generate a block movement signal, generating a first, second and third loading signal when the block movement signal is asserted, receiving the start address, destination address and move length when the first, second and third loading signal are asserted respectively, during a read cycle, outputting the start address to the memory device to retrieve data of a buffer length at a location beginning from the start address in the memory device and transferring the data into a buffer, during a write cycle, outputting the destination address to the memory device and transferring the data from the buffer into the memory device at a location beginning from the destination address, and subtracting the move length by the buffer length, and adding the buffer length to the start address and destination address.

Thus, in the present invention, by a circuit dedicated for block movement, the CPU or DSP does not need to move blocks in the memory by itself. The CPU or DSP only needs to transmit a block movement command to activate the block movement circuit.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a diagram showing an apparatus for memory device block movement according to one embodiment of the invention.

FIGS. 2A and 2B are diagrams showing the timing of the signals used in the apparatus shown in FIG. 1.

FIG. 3 is a flowchart of a method for memory device block movement according to one embodiment of the invention.

### DETAILED DESCRIPTION OF THE INVENTION

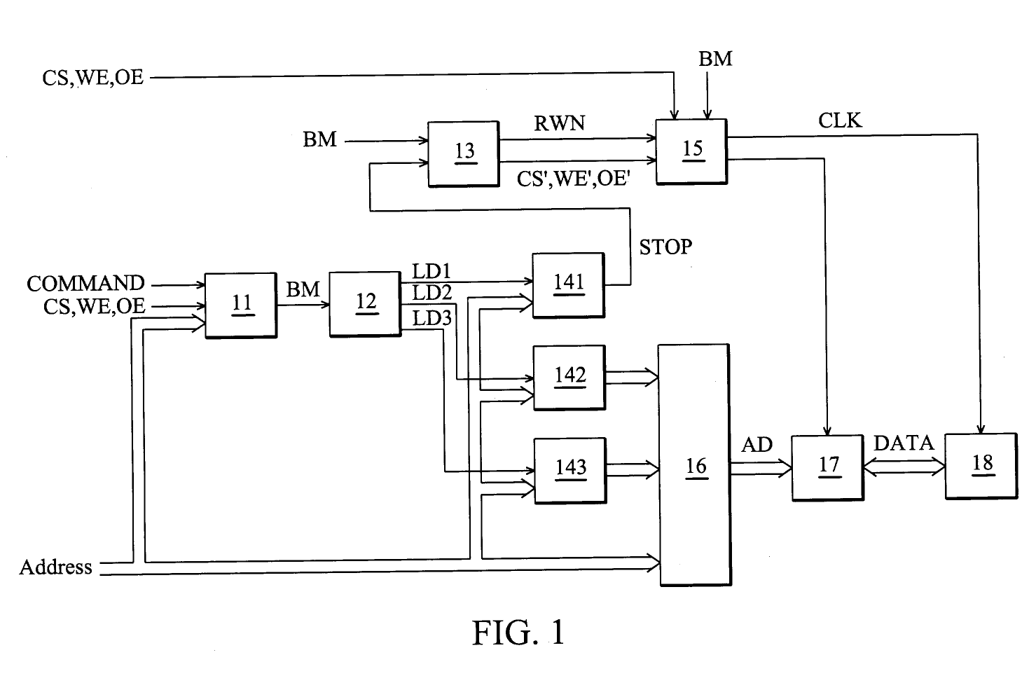

FIG. 1 is a diagram showing an apparatus for memory device block movement according to one embodiment of the invention. It includes a block movement command decoder 11, a block movement address programming circuit 12, a block movement read/write control circuit 13, a move length counter 141, a start address counter 142, a destination address counter 143, a control signal unit 15, a multiplexer 16, a main memory (1T-SRAM, SDRAM, LPSRAM or flash memory) 17 and a data buffer 18. The block movement command decoder 11 receives a block movement command composed of a signal Address, external chip select signal CS, external write enable signal WE and external output enable signal OE from the CPU or DSP (not shown). The signal Address carries a start address, a destination address and a move length for block move. The block movement command decoder 11 also receives a signal Command to identify if the block movement command is transmitted by the CPU or DSP. The block movement movement command is decoded by the block movement command decoder 11 so that a block movement signal BM is generated. The block movement address programming circuit 12 generates loading signal LD1, LD2 and LD3 when the block movement signal BM is asserted. The start address counter 142, destination address counter 143 and move length counter 141 receive the start address, destination address and move length when the loading signal LD1, LD2 and LD3 are asserted respectively. During a read cycle, the multiplexer 16 selects the start address sent from the counter 142 as its output AD to the main memory 17 and data of a length equal to the length of the buffer 18 at a location beginning from the start address in the main memory 17 is retrieved. The retrieved data is transferred into the buffer 18. During a write cycle, the multiplexer 16 selects the destination address sent from the counter 143 as its output AD to the main memory 17 and the data retrieved during the read cycle is transferred from the buffer 18 into the main memory 17 at a location beginning from the destination address. After the first read and write cycle are completed, the counter 141 subtracts the move length by the length of the buffer 18. For example, if the move length is 32 and the buffer length is 4, the move length in the counter 141 after the first read and write cycle will be 28. A long buffer length will shorten the time for block movement. Similarly, the counters 142 and 143 add the buffer length to the start address and destination address. The read and write cycles are repeated until the move length in the counter 141 deceases to zero. The counter 141 generates a stop signal STOP when the move length is zero. The block movement read/write control circuit 13 generates an internal chip select signal CS′, select signal CS′, internal write enable signal WE′ and internal output enable signal OE′ when the block movement signal BM is asserted, and generates a read/write normal signal RWN when the stop signal STOP is asserted. The control signal unit 15 generates a clock signal CLK to the buffer 18 and outputs the internal chip select signal CS′, internal write enable signal WE′ and internal output enable signal OE′ to the main memory 17 when the block movement signal BM is asserted, and outputs the external chip select signal CS, external write enable signal WE and external output enable signal OE to the main memory 17 when the read/write normal signal RWN is asserted.

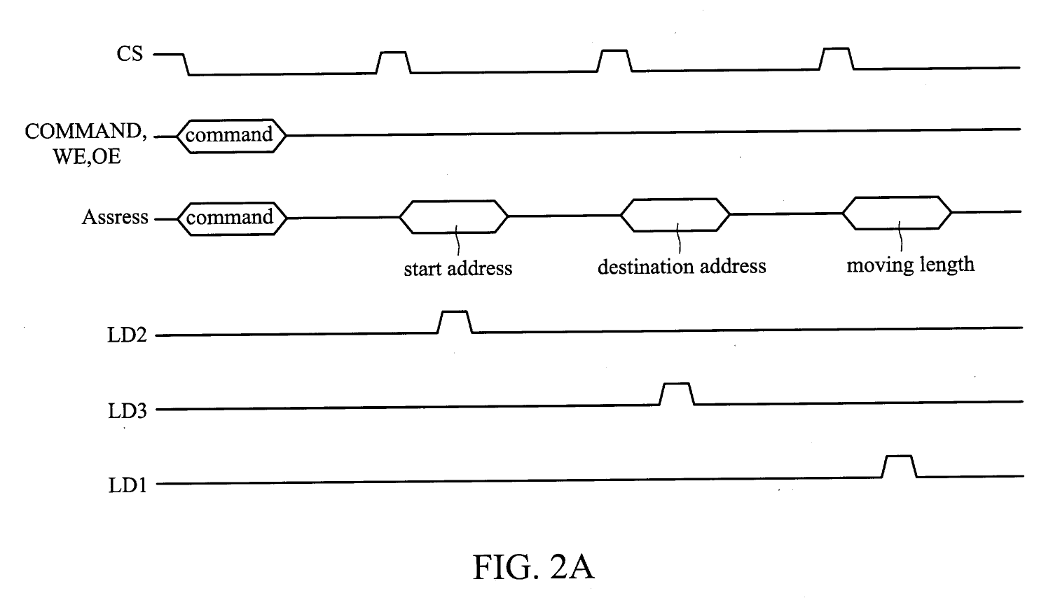

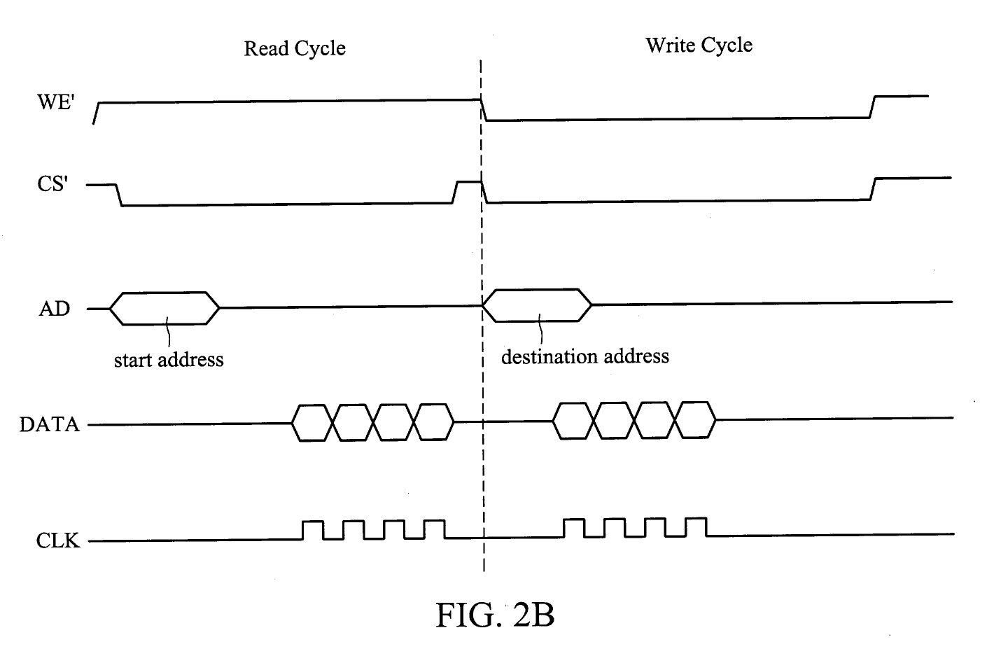

FIG. 2A is a diagram showing the timing of the signals used in the apparatus shown in FIG. 1 before the read and write cycle start. The CPU or DSP sends the block movement command in the signals CS, COMMAND, WE, OE and Address. The start address, destination address and move length are carried in the signal Address. The loading signals LD1, LD2 and LD3 have pulses which help to send the move length, start address and destination address into the counters 141, 142 and 143 respectively.

FIG. 2B is a diagram showing the timing of the signals used in the apparatus shown in FIG. 1 during the read and write cycle. During the read cycle, the internal write enable signal WE′ has a high voltage level and the start address is sent to the main memory 17 through the output signal AD from the multiplexer 16. As the clock signal CLK is sent to the buffer 18, the desired data is sent to the buffer 18. During the write cycle, the internal write enable signal WE′ has a low voltage level and the destination address is sent to the main memory 17 through the output the output signal AD from the multiplexer 16. As the clock signal CLK is sent to the buffer 18, the data in the buffer 18 is transferred to the main memory 17.

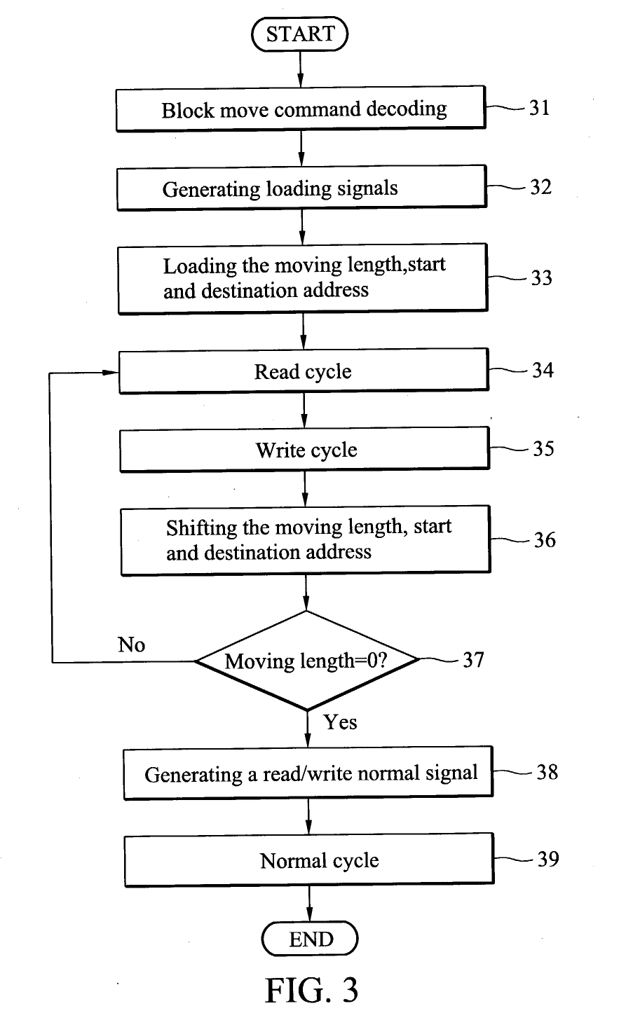

FIG. 3 is a flowchart of a method for memory device block movement according to one embodiment of the invention. The memory device may be an 1T-SRAM, DRAM, LPSRAM or flash memory.

In step 31, a block movement command carrying a start address, destination address and move length is decoded to generate a block movement signal.

In step 32, when the block movement signal is asserted, a first, second and third loading signal are generated, an internal chip select signal, internal write enable signal, internal output enable signal are also generated and output to the memory device, and a clock signal is output to a buffer.

In step 33, the start address, destination address and move length are received when the first, second and third loading signal are asserted respectively.

In step 34, during a read cycle, the start address is output to a memory device to retrieve data of a buffer length at a location beginning from the start address in the memory device. The retrieved data is transferred into the buffer. The data retrieving and transferring are controlled by the clock signal output to the buffer, the internal chip select signal, internal write enable signal and internal output enable signal.

In step 35, during a write cycle, the destination address is output to the memory device. The data in the buffer is transferred into the memory device at a location beginning from the destination address.

In step 36, the move length is subtracted by the buffer length, and the buffer length is added to the start address and destination address.

In step 37, a stop signal is generated when the move length decreases to zero. Otherwise, the steps 35 and 36 are repeated until the move length is zero.

In step 38, a read/write normal signal is generated when the stop signal is asserted.

In step 39, when the read/write normal signal is asserted, an external chip select signal, external write enable signal and external output enable signal are output to the memory device for normal read and write operation.

In conclusion, the present invention provides a smart 1T-SRAM, SRAM, SDRAM or flash memory with block movement function. By a circuit dedicated for block movement, the CPU or DSP does not need to move blocks in the memory by itself. The CPU or DSP only needs to transmit a block movement command to activate the block movement circuit. This avoids interruption and performance degradation of the DSP or CPU.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. An apparatus for memory device block movement comprising:
means for decoding a block movement command carrying a start address, destination address and move length to generate a block movement signal;
means for generating a first, second and third loading signal when the block movement signal is asserted;
means for receiving the start address, destination address and move length when the first, second and third loading signal are asserted respectively;
means for outputting the start address to the memory device to retrieve data of a buffer length at a location beginning from the start address in the memory device and transferring the data into a buffer during a read cycle;
means for outputting the destination address to the memory device and transferring the data from the buffer into the memory device at a location beginning from the destination address during a write cycle; and
means for subtracting the move length by the buffer length, and adding the buffer length to the start address and destination address.

2. The apparatus as claimed in claim 1, wherein means for decoding is a block movement command decoder.

3. The apparatus as claimed in claim 1, wherein means for generating the first, second and third loading signal is a block movement address programming circuit.

4. The apparatus as claimed in claim 1, wherein means for receiving the start address, destination address and move length when the first, and subtracting the move length by the buffer length, and adding the buffer length to the start address and destination address are counters.

5. The apparatus as claimed in claim 1, wherein means for outputting the start address to the memory device during the read cycle and means for outputting the destination address to the memory device during the write cycle are one multiplexer.

6. The apparatus as claimed in claim 1 further comprising:
means for generating a stop signal when the move length decreases to zero;
means for generating an internal chip select signal, internal write enable signal and internal output enable signal when the block movement signal is asserted, and generating a read/write normal signal when the stop signal is asserted; and
means for generating a clock signal to the buffer and outputting the internal chip select signal, internal write enable signal and internal output enable signal to the memory device when the block movement signal is asserted, and outputting an external chip select signal, external write enable signal and external output enable signal to the memory device when the read/write normal signal is asserted.

7. The apparatus as claimed in claim 6, wherein means for generating the stop signal is a counter.

8. The apparatus as claimed in claim 6, wherein means for generating the internal chip select signal, internal write enable signal, internal output enable signal and the read/write normal signal is a block movement read/write control circuit.

9. The apparatus as claimed in claim 6, wherein means for generating a clock signal to the buffer and outputting the internal chip select signal, internal write enable signal and internal output enable signal to the memory device is a control signal unit circuit.

10. The apparatus as claimed in claim 1, wherein the memory device comprises an SRAM.

11. The apparatus as claimed in claim 1, wherein the memory device comprises an DRAM.

12. The apparatus as claimed in claim 1, wherein the memory device comprises an 1T-SRAM.

13. The apparatus as claimed in claim 1, wherein the memory device comprises a flash memory.

14. A method for memory device block movement comprising the steps of:
decoding a block movement command carrying a start address, destination address and move length to generate a block movement signal;
generating a first, second and third loading signal when the block movement signal is asserted;
receiving the start address, destination address and move length when the first, second and third loading signal are asserted respectively;
during a read cycle, outputting the start address to the memory device to retrieve data of a buffer length at a location beginning from the start address in the memory device and transferring the data into a buffer;
during a write cycle, outputting the destination address to the memory device and transferring the data from the buffer into the memory device at a location beginning from the destination address; and
subtracting the move length by the buffer length, and adding the buffer length to the start address and destination address.

15. The method as claimed in claim 14 further comprising the steps of:
generating a stop signal when the move length decreases to zero;
generating an internal chip select signal, internal write enable signal and internal output enable signal when the block movement signal is asserted, and generating a read/write normal signal when the stop signal is asserted; and
generating a clock signal to the buffer and outputting the internal chip select signal, internal write enable signal and internal output enable signal to the memory device when the block movement signal is asserted, and outputting an external chip select signal, external write enable signal and external output enable signal to the memory device when the read/write normal signal is asserted.

16. The method as claimed in claim 14, wherein the memory device comprises an SRAM.

17. The method as claimed in claim 14, wherein the memory device comprises an DRAM.

18. The method as claimed in claim 14, wherein the memory device comprises a 1T-SRAM.

19. The method as claimed in claim 14, wherein the memory device comprises a flash memory.
